(19) United States
(12) Patent Application Publication
(10) Pub. No.: US 2004/0239098 A1
(43) Pub. Date: Dec. 2, 2004

(54) Article and method of fabrication thereof for providing tamper detection evidence

(76) Inventor: Paul Grady Russell, Campbell, CA (US)

Correspondence Address: HEWLETT-PACKARD COMPANY, Intellectual Property Administration, P.O. Box 272400, Fort Collins, CO, 80527-2400, US

(21) Appl. No.: 10/446,559

(22) Filed: May 27, 2003

(51) Int. Cl. B42D 15/00

(52) U.S. Cl. 283/72

(57) ABSTRACT

The present invention includes an article and a method of fabrication thereof for providing tamper detection evidence. In an embodiment, the article is an adhesive tape that includes a pattern of printed indicia thereon wherein the printed indicia includes a textual message translated into a plurality of different languages. Based on the pattern of printed indicia, it is easy to determine whether the tape has been previously cut or removed since it would be extremely difficult, if not impossible, to realign the pattern of printed indicia once the article has been removed. Additionally, the present invention meets the regulatory requirements of many countries that require all text (not trademarked logos) to be translated into the language of the country in which the article is being utilized. An aspect of the present invention is an article for providing tamper detection evidence. The article includes a film layer, printed indicia on the film layer wherein the printed indicia includes a textual message translated into a plurality of different languages and a layer of adhesive affixed to the film layer.

### FIELD OF THE INVENTION

The present invention relates generally to package security and more particularly to an article and method of fabrication thereof for providing tamper detection evidence.

### BACKGROUND OF THE INVENTION

Security laminates are traditionally used to protect documents or packages to ensure that the underlying items are not altered. Security laminates are particularly useful on boxes and on other important documents such as certificates of title. Security laminates are also useful as protective labels on medications, videocassettes, and compact discs.

Security laminates are constructed of various materials. In order to overcome the problem of counterfeit documents, manufacturers have made it exceedingly difficult for counterfeiters to duplicate the security laminate used on a particular document. Some constructions require special viewing devices to discern whether or not the laminate was subjected to tampering. These laminates were multilayer films comprising a monolayer of microspheres at least partially embedded in a binder layer, typically with associated specular or diffuse reflective layers, to impart a retro reflective appearance to the document. The microsphere-containing layer is printed with a customer-specified logo. The retro reflective layer is then adhesively bound to the document. These constructions are difficult to imitate by counterfeiters because it is difficult to imitate the customer-specific retro reflective printing.

However, in order to determine authenticity of the laminates, special retro reflective viewing equipment is required to view the customer-specific printing. Tampering is indicated by damage to the continuity of the retro reflective layer, visible as dark lines or discoloration which does not retro reflect. Therefore, it is difficult to detect authenticity of the document with the naked eye. This type of laminate is also expensive to manufacture due to multiple layers and a sophisticated process control which is necessary to manufacture the laminate.

Four features are particularly important when producing and using security laminates. First, once applied to an article it is important that the laminate be difficult to remove to ensure that the underlying item is not altered or subjected to tampering. Second, a desirable laminate is difficult if not impossible to duplicate by counterfeiters. Third, if tampering occurs it is important to quickly and accurately recognize an altered or counterfeit laminate. Fourth, it is important that manufacturing and application costs of the laminates are not prohibitively expensive.

Accordingly, what is needed is a method for providing tamper detection evidence in a simple and inexpensive fashion. The present invention addresses these needs.

### SUMMARY OF THE INVENTION

The present invention includes an article and a method of fabrication thereof for providing tamper detection evidence. In an embodiment, the article is an adhesive tape that includes a pattern of printed indicia thereon wherein the printed indicia includes a textual message translated into a plurality of different languages. Based on the pattern of printed indicia, it is easy to determine whether the tape has been previously cut or removed. Additionally, the present invention meets the regulatory requirements of many countries that require all text (not trademarked logos) to be translated into the language of the country in which the article is being utilized.

A first aspect of the present invention is an article for providing tamper detection evidence. The article includes a film layer, printed indicia on the film layer wherein the printed indicia includes a textual message translated into a plurality of different languages and a layer of adhesive affixed to the film layer.

A second aspect of the present invention is a method of providing tamper detection evidence. The method includes providing a film layer, printing indicia on the film layer wherein the indicia comprises a textual message translated into a plurality of different languages and affixing a layer of adhesive to the film layer.

A third aspect of the present invention is an adhesive tape for providing tamper evidence. The adhesive tape includes a film layer wherein the film layer includes an underside, a pattern of printed indicia on the underside wherein the pattern of printed indicia comprises a textual message translated into a plurality of different languages and a layer of pressure sensitive adhesive affixed to the film layer.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a high-level flow chart of a method in accordance with an embodiment of the present invention.

FIG. 2 is an illustration of an article for providing tamper detection evidence in accordance with an embodiment of the present invention.

FIG. 3 shows an example of printed indicia that can be utilized in conjunction with an embodiment of the present invention.

FIG. 4 shows a pattern of printed indicia that could be implemented in conjunction with an embodiment of the present invention.

FIG. 5 shows the pattern repeated three times on the underside of the adhesive tape in accordance with an embodiment of the present invention.

FIG. 6 shows an altered article that includes a misaligned pattern of printed indicia.

### DETAILED DESCRIPTION

The present invention relates to an article and a method of fabrication thereof for providing tamper detection evidence. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

The present invention includes an article and a method of fabrication thereof for providing tamper detection evidence. In an embodiment, the article is an adhesive tape that includes a pattern of printed indicia thereon wherein the printed indicia includes a textual message translated into a plurality of different languages. Based on the pattern of printed indicia, it is easy to determine whether the tape has been previously cut or removed. Additionally, the present invention meets the regulatory requirements of many countries that require all text (not trademarked logos) to be translated into the language of the country in which the article is being utilized.

Please refer now to FIG. 1. FIG. 1 is a high level flowchart of a method of fabricating an article for providing tamper detection evidence in accordance with an embodiment of the present invention. A first step 110 includes providing a film layer. A second step 120 includes printing indicia on the film layer wherein the indicia includes a textual message translated into a plurality of different languages. A final step 130 includes affixing a layer of adhesive to the film layer. In an embodiment, the film layer is transparent whereby the printed indicia can be seen through the film layer.

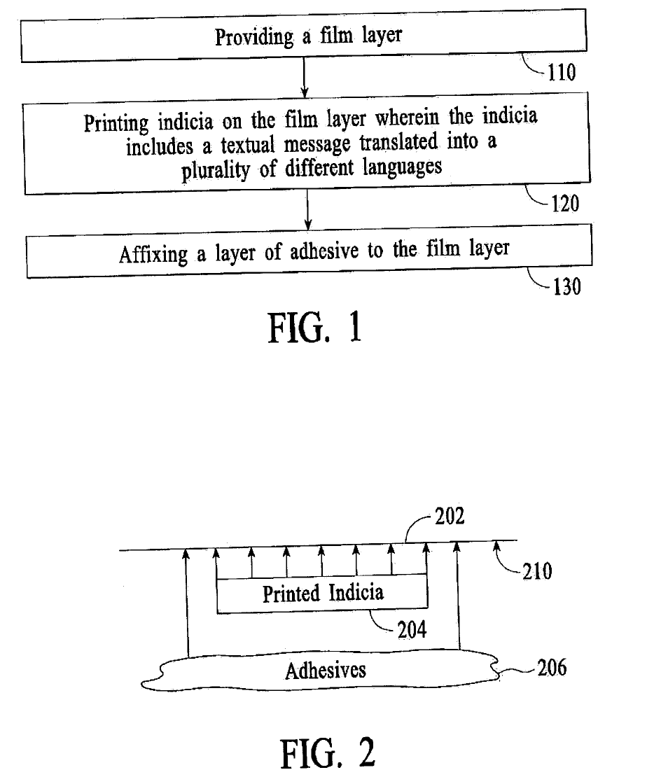

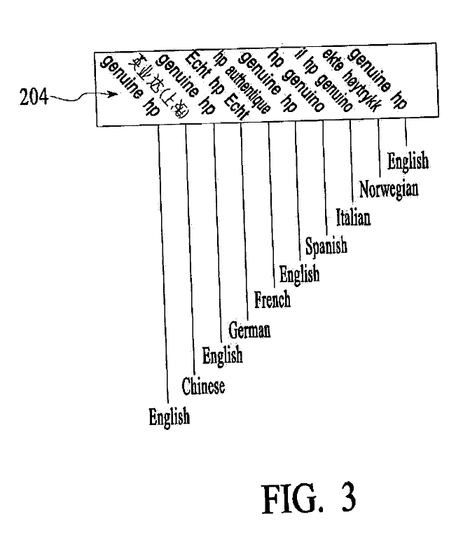

Please refer now to FIG. 2. FIG. 2 shows an article 200 in accordance with an embodiment of the present invention. In an embodiment, the article is an adhesive tape. The article 200 includes a transparent film layer 202, printed indicia 204 and a layer of adhesive 206. The printed indicia 204 and the adhesive layer are affixed to an underside 210 of the transparent film layer 202.

In an embodiment, the adhesive layer 206 can be a pressure-sensitive adhesive. For example, a pressure sensitive adhesive such as 3M Brand High Temperature Acrylic Pressure Sensitive Adhesive #966 (3M Company, St. Paul, Minn.) can be used. Pressure sensitive adhesives are less expensive and easier to adhere than, for example, heat activated adhesives. Additionally, heat activated adhesives must be applied with a heat laminator thereby increasing the cost of the manufacturing process.

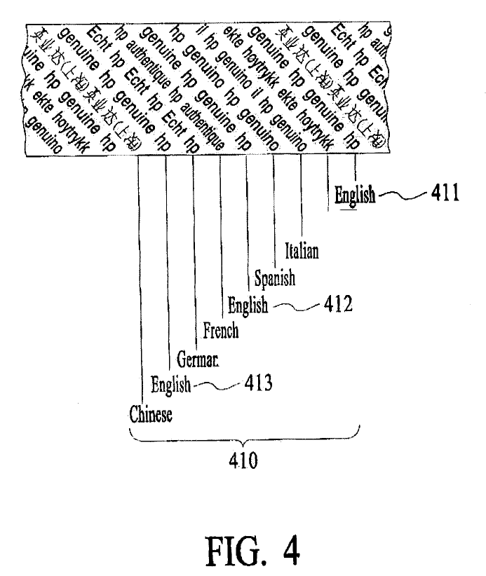

In an embodiment, the article 200 includes printed indicia on its underside 210 to further enhance its tamper detection capability. FIG. 3 shows an example of printed indicia 204 in accordance with an embodiment of the present invention. As can be seen in FIG. 3, the printed indicia 204 wherein the printed indicia 204 includes a textual message translated into a plurality of different languages. In the illustrated embodiment, the printed indicia 204 includes English, Norwegian, Italian, Spanish, French, German and Chinese translations of the textual message “genuine hp”. (It should be noted that the illustrated translations are not approved translations.) To further enhance the tamper detection capability of the article 200, a pattern of printed indicia can be implemented. FIG. 4 shows a pattern of printed indicia 410 that could be implemented in conjunction with an embodiment of the present invention. As can be seen in FIG. 4, the pattern 410 is a “3-2-1” pattern. What is meant by a 3-2-1 pattern is a pattern where a base language is employed and other languages are placed adjacent to the base language in a 3-2-1 configuration. In FIG. 4, the base language is English. Accordingly, as can be seen in FIG. 4, the pattern 410 includes a first English translation 411 of the textual message “genuine hp” followed by three translations of the textual message into languages other than English (Norwegian, Italian and Spanish). Next, a second English translation 412 is followed by two translations of the textual message into languages other than English (French and German) and different from the other non-English language translations. Finally, a third English translation 413 is followed by a single translation of the textual message into a language other than English (Chinese) and different from the other non-English language translations.

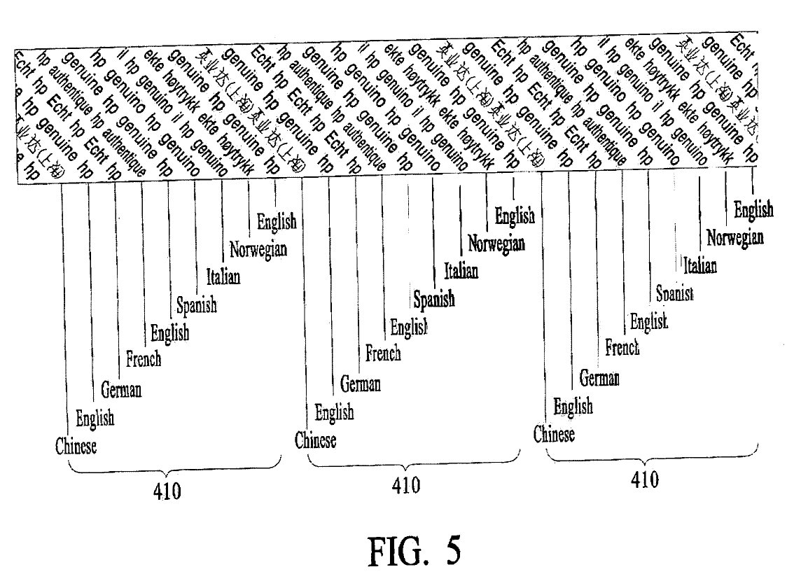

Although FIG. 4 shows a single pattern 410, the pattern could be repeated over the entire underside of the transparent film layer. FIG. 5 shows the pattern 410 repeated three times on the underside of the transparent film layer in accordance with an embodiment of the present invention.

Although the above disclosed embodiment implements a “3-2-1” type pattern, one of ordinary skill in the art will readily recognize that a variety of different patterns could be implemented while remaining within the spirit and scope of the present invention.

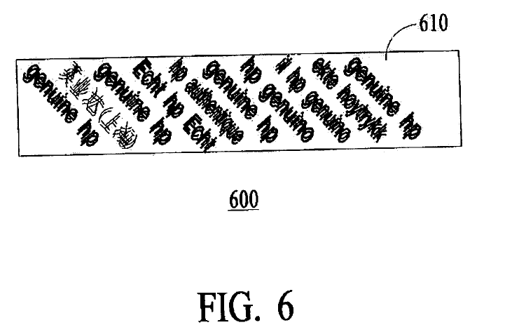

Accordingly, through the combined use of pressure sensitive adhesives and patterns of printed indicia that include multiple translations of a textual message, a user can easily determine whether the article 200 has been delaminated/removed. For example, assume the article 200 has been affixed to a package containing manufactured goods. If an interloper attempts to duplicate the article 200 utilized on the package, removes or alters the contents of the package and subsequently attempts to re-affix a duplicated article to the package, the pattern of printed indicia on the duplicated article will be extremely difficult to align properly. FIG. 6 shows an altered article 600 that includes a misaligned pattern of printed indicia 610. Consequently, a receiver of the package can readily observed that the package has been tampered with based on the observation of the misaligned pattern of printed indicia 610.

Accordingly, the utilization of the present invention is advantageous from for three main reasons. First, once applied to a package, the article is difficult to be unnoticeably removed because of the pressure sensitive adhesive. Second, if tampering occurs, it can be quickly and accurately recognized since it would be extremely difficult, if not impossible, to realign the pattern of printed indicia once the article has been removed from a package. Third, the manufacturing and application costs of the article is not prohibitively expensive.

An article and a method of fabrication thereof for providing tamper detection evidence are disclosed. In an embodiment, the article is an adhesive tape that includes a pattern of printed indicia thereon wherein the printed indicia includes a textual message translated into a plurality of different languages. Based on the pattern of printed indicia, it is easy to determine whether the tape has been previously cut or removed. Additionally, the present invention meets the regulatory requirements of many countries that require all text (not trademarked logos) to be translated into the language of the country in which the article is being utilized.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed:

1. An article for providing tamper detection evidence comprising:
a film layer;
printed indicia on the film layer wherein the printed indicia comprises a textual message translated into a plurality of different languages; and
a layer of adhesive affixed to the film layer.

2. The article of claim 1 wherein the film layer is transparent and includes an underside whereby the printed indicia is on the underside of the film layer.

3. The article of claim 1 wherein the printed indicia further comprises a pattern.

4. The article of claim 3 wherein the pattern is repeated on the underside of the film layer.

5. The article of claim 1 wherein the pattern comprises multiple occurrences of the textual message wherein each occurrence of the textual message comprises a translation of the textual message into a language different from each other occurrence.

6. The article of claim 5 wherein the pattern comprises a 3-2-1-type pattern.

7. The article of claim 1 wherein layer of adhesive comprises a pressure sensitive adhesive.

8. A method of fabricating an article for providing tamper detection evidence comprising:
providing a film layer of adhesive;
printing indicia on the film layer wherein the indicia comprises a textual message translated into a plurality of different languages; and
affixing a layer of adhesive to the film layer.

9. The method of claim 8 wherein the film layer is transparent and includes an underside whereby the act of printing indicia on the film layer further comprises printing indicia is on the underside of the film layer.

10. The method of claim 9 wherein the printed indicia comprises a pattern.

11. The method of claim 10 wherein the pattern is repeated on the film layer.

12. The method of claim 8 wherein the pattern comprises multiple occurrences of the textual message wherein each occurrence of the textual message comprises a translation of the textual message into a language different from each other occurrence.

13. The method of claim 12 wherein the pattern comprises a 3-2-1-type pattern.

14. The method of claim 13 wherein layer of adhesive comprises a pressure sensitive adhesive.

15. An adhesive tape for providing tamper evidence comprising:
a film layer wherein the film layer includes an underside;
a pattern of printed indicia on the underside of the film layer wherein the pattern of printed indicia comprises a textual message translated into a plurality of different languages; and
a layer of pressure sensitive adhesive affixed to the film layer.

16. The adhesive tape of claim 15 wherein the pattern is repeated on the film layer.

17. The adhesive tape of claim 16 wherein the pattern comprises multiple occurrences of the textual message wherein each occurrence of the textual message comprises a translation of the textual message into a language different from each other occurrence.

18. The adhesive tape of claim 17 wherein the pattern comprises a 3-2-1-type pattern.
